(19) United States
(12) Patent Application Publication
(10) Pub. No.: US 2010/0148680 A1
(43) Pub. Date: Jun. 17, 2010

(54) LED LIGHT STRING CAPABLE OF INCREASING THE NUMBER OF LEDS WITHOUT ADDING EXTENSION PLUGS AND SOCKETS

(76) Inventor: Chen-Sheng YANG, Kaohsiung (TW)

Correspondence Address: RABIN & Berdo, PC, 1101 14TH STREET, NW, SUITE 500, WASHINGTON, DC, 20005, US

(21) Appl. No.: 12/335,888

(22) Filed: Dec. 16, 2008

(51) Int. Cl. F21S 4/00

(52) U.S. Cl. 315/185 S

(57) ABSTRACT

An LED light string has a plug with two front diodes, an extension socket with two rear diodes, multiple LED units connected between the plug and the extension socket, and multiple intermediate diodes connected to the LED units. The intermediate diodes, the two front diodes and the two rear diodes are connected to form multiple bridge rectifiers. The multiple bridge rectifiers are connected to an AC voltage in parallel and drive the LED units, respectively.

### BACKGROUND OF THE INVENTION

1. Field of the Invention

The invention relates to a light emitting diode (LED) light string, and more particularly to an LED light string capable of expanding the number of LEDs used in the light string without having additional extension plugs and sockets.

2. Description of Related Art

With reference to FIGS. 4 to 6, a conventional LED light string is composed of a plug (50), an extension socket (52) and multiple light emitting diodes (LEDs) (54) connected between the plug (50) and the extension socket (52). The plug (50) has two conductive contacts (501) for electrically connecting an AC voltage (60) and two first diodes (502). The extension socket (52) has two slots (521) for correspondingly connecting a plug of a subsequent LED light string. The extension socket (52) has two second diodes (522).

The two first diodes (502) in the plug and the second diodes (522) form a bridge rectifier to convert the AC voltage to a DC voltage supplied to drive the LEDs (54). To construct a relative long light string, multiple foregoing LED light strings should be connected sequentially by fitting the conductive contacts (501) of a next LED light string into the two slots (521) of a previous LED light string. However, such a connection way requires that each LED light string must have an additional plug (50) and an extension socket (52). The manufacturing cost and selling price of the LED light string is accordingly high and expensive.

### SUMMARY OF THE INVENTION

The main objective of the present invention is to provide an LED light string capable of expanding the number of the LEDs used in the light string without having additional extension plugs and sockets.

To accomplish the objective, the LED light string in accordance with the present invention has a plug with two front diodes, an extension socket with two rear diodes, multiple LED units connected between the plug and the extension socket, and multiple intermediate diodes connected to the LED units. The intermediate diodes, the two front diodes and the two rear diodes are connected to form multiple bridge rectifiers. The multiple bridge rectifiers are connected to an AC voltage in parallel and drive the LED units, respectively.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an LED light string in accordance with the present invention;

FIG. 2 is a cross sectional view in partial of the LED light string of FIG. 1 in accordance with the present invention;

FIG. 3 is an equivalent circuit of the LED light string of FIG. 1 in accordance with the present invention;

FIG. 4 is a perspective view of a conventional LED light string with a front plug and a rear extension socket;

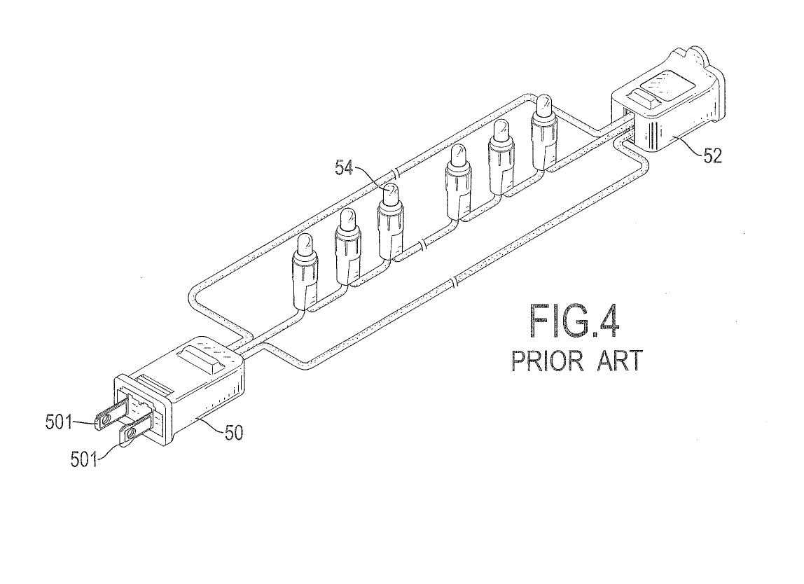

FIG. 5 is a cross sectional view in partial of the conventional LED light string of FIG. 4; and

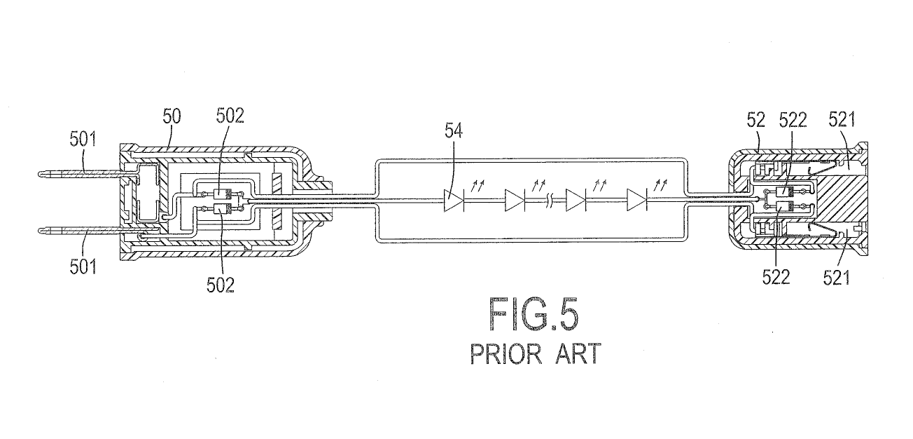

FIG. 6 is an equivalent circuit of the conventional LED light string of FIG. 4.

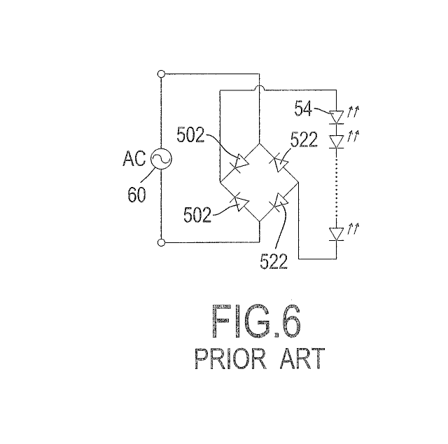

### DETAILED DESCRIPTION OF THE PREFERRED EMBODIMENT

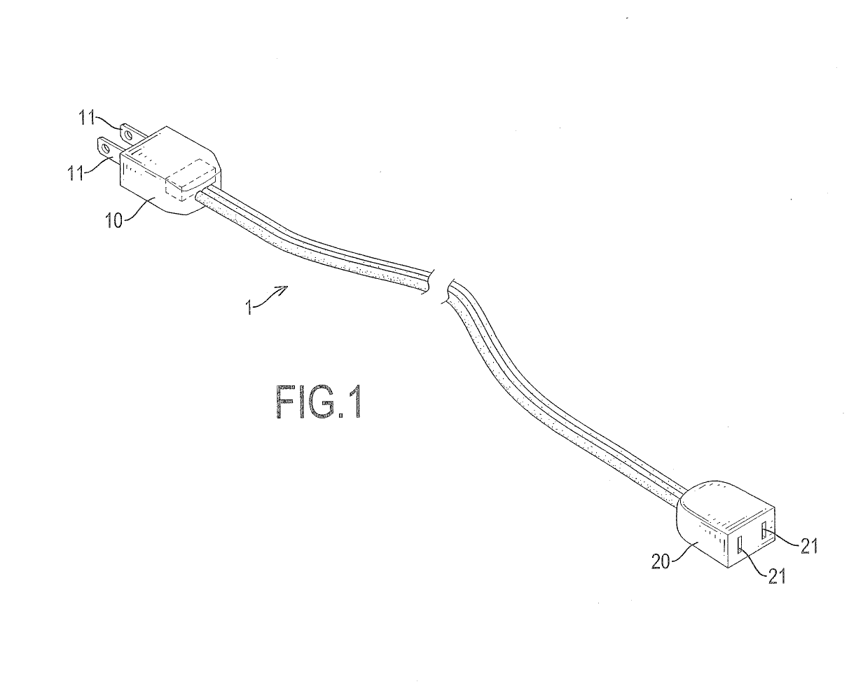

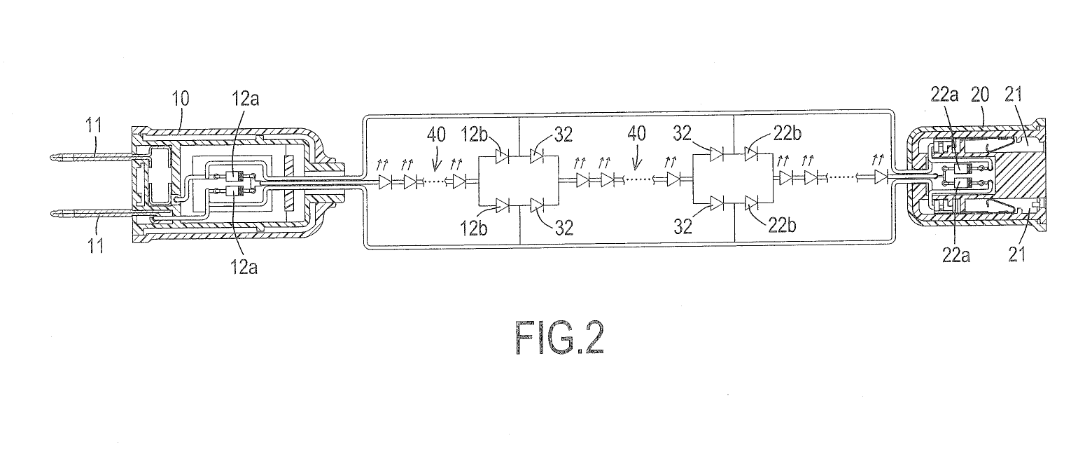

With reference to FIGS. 1 to 3, an LED light string (1) in accordance with the present invention comprises a plug (10), an extension socket (20), multiple bridge rectifiers (30) and multiple LED units (40).

The plug (10) has a chamber, two contacts (11) protruding from the chamber for electrically receiving an AC voltage, and two front diodes (12a) mounted in the chamber and connected to the two contacts (11).

The extension sockets (20) has a chamber, two slots (21) and two rear diodes (22a) mounted in the chamber.

Each of the multiple bridge rectifiers (30) is a full bridge rectifier and comprises four diodes. In this embodiment, three bridge rectifiers (30) are provided in the LED light string as an example. Using more than two bridge rectifiers (30) in an LED light string is practicable to meet different required situations. In addition to the front and rear diodes (12a) (22a) mounted in the plug (10) and the extension socket (20), the other intermediate diodes (12b) (22b) (32) are distributed among the LED units (40) between the plug (10) and the extension socket (20). Preferably, two intermediate diodes (12b) of a present bridge rectifier are connected to the other two intermediate diodes (32) of a subsequent bridge rectifier. In other words, every four intermediate diodes (12b, 32) (32, 22b) connected between two LED units (40) is a group, but the four intermediate diodes in the same group belong to two different bridge rectifiers (30).

For example, in addition to the two front diodes (12a), the first rectifier (30) further has first two intermediate diodes (12b). The second rectifier (30) comprises four second intermediate diodes (32). The last bridge rectifier (30) is consisted of the two rear diodes (22a) and last two intermediate diodes (22b).

Each LED unit (40) is driven by a corresponding bridge rectifier (30), and is composed of multiple of light emitting diodes (LEDs) connected in series.

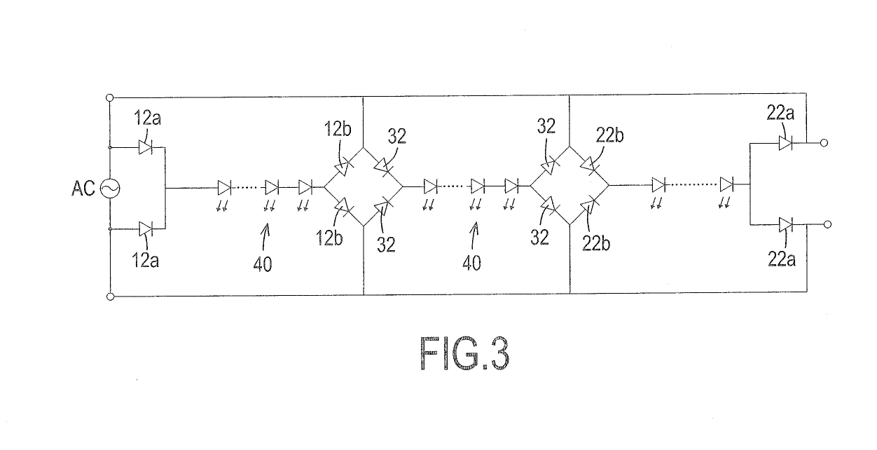

As shown on FIG. 3, since all the bridge rectifiers (30) are all connected to the AC voltage in parallel and respectively drives an LED unit (40), the number of the LEDs in the light string can be increased to meet required purpose by adding intermediate diodes (32) to form bridge rectifiers (30) in the light string. Therefore, a relative long LED light string can be easily manufactured in accordance with the present invention without connecting different individual light strings in sequence with additional plugs and sockets.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light emitting diode (LED) light string comprising:
a plug having
a chamber; and
two front diodes mounted in the chamber for electrically connecting to an AC voltage;
an extension plug having
a chamber; and
two rear diodes mounted in the chamber of the extension plug for electrically connecting to the AC voltage;
multiple intermediate diodes connected to the LED units, the intermediate diodes, the two front diodes and the two rear diodes constructing multiple bridge rectifiers;
multiple LED units connected between the plug and the extension socket, having multiple light emitting diodes (LEDs) connected in series, and electrically connect to the AC voltage in parallel and respectively drive the multiple LED units.

2. The LED light string as claimed in claim 1, wherein each bridge rectifier is a full bridge rectifier and is composed of four diodes.

3. The LED light string as claimed in claim 2, wherein every four of the intermediate diodes is connected as a group between two adjacent LED units.

4. The LED light string as claimed in claim 3, wherein the four intermediate diodes in the same group belong to two different bridge rectifiers.

5. The LED light string as claimed in claim 3, wherein the two front diodes and first two of the intermediate diodes form a first bridge rectifier; and last two of the intermediate diodes and the two rear diodes form a last bridge rectifier.

6. The LED light string as claimed in claim 5, wherein the two front diodes and first two of the intermediate diodes form a first bridge rectifier; and last two of the intermediate diodes and the two rear diodes form a last bridge rectifier.
